(19) United States
(12) Patent Application Publication
(10) Pub. No.: US 2026/0264733 A1
(43) Pub. Date: Sep. 10, 2026

(54) Powered Wheel Assembly

(71) Applicant: Colson Group Holdings, LLC, Oakbrook Terrace, IL (US)

(72) Inventor: Vincent Leman, St. Joseph, MI (US)

(21) Appl. No.: 19/545,150

(22) Filed: Feb. 20, 2026

Related U.S. Application Data
(60) Provisional application No. 63/766,490, filed on Mar. 4, 2025.

(51) Int. Cl. B62B 5/00

(52) U.S. Cl. CPC B62B 5/004; B62B 5/005

(57) ABSTRACT

A motorized wheel assembly for attachment to various devices. The device comprises an internally-housed motor coupled to a wheel via a drive shaft and gearing system, means for control, and a mounting point. The device is configured for mechanical fastening to larger objects to provide locomotion to either assist a user or to provide autonomous transportation.

### RELATED APPLICATION DATA

This application claims priority benefit to U.S. provisional application Ser. No. 63/766,490, filed Mar. 4, 2025, the disclosure of which is incorporated by reference.

### BACKGROUND

This disclosure is directed to a powered wheel assembly that may be used with transport carts, automated guided vehicles, cart movers, motorized assists and pallet jacks, and other material handling applications. The powered wheel assembly may be integrated into original equipment or retrofitted into existing material handling applications. The powered wheel assembly may be part of an overall system including: (i) user controls for controlling the powered wheel assembly, for instance, the speed, the direction (forward, reverse), and braking, (ii) a motor driver that interfaces with the motor and generates commands to the motor based on user inputs from the user controls, and (iii) a battery power source.

More in particular, this disclosure is directed to a powered wheel assembly with an integrated motor and gear drive for powering a wheel of the powered wheel assembly. More in particular, this disclosure is directed to a powered wheel assembly with an integrated motor, and a gear drive comprising a cycloidal gear drive with a hub for supporting the wheel that is centered relative to the motor and the cycloidal gear drive. As will be described in greater detail below, the powered wheel assembly comprising three subassemblies: a motor subassembly, a gear drive subassembly, and a hub subassembly that is disposed between the motor subassembly and the gear drive subassembly. The three subassemblies are arranged in a manner so as to provide a compact configuration that balances weight distribution of the overall powered wheel assembly while delivering a required torque for the application.

### DESCRIPTION OF THE DRAWINGS

FIG. 1 is a schematic diagram of a system including the exemplary powered wheel assembly.

FIG. 2 is a perspective cross section of the exemplary powered wheel assembly.

FIG. 3 is an exploded perspective view of a motor subassembly of the powered wheel assembly of FIG. 2, including a motor and a motor housing.

FIG. 4 is an exploded perspective view of a gear drive subassembly of the powered wheel assembly of FIG. 2, including a cycloidal gear drive and a gear housing.

FIG. 5 is an alternate exploded perspective view of a cycloidal gear drive and a gear housing of gear drive subassembly of the powered wheel assembly of FIG. 2.

FIG. 6 is a perspective view of a hub assembly of the powered wheel assembly of FIG. 2 with the motor housing and gear housing removed for ease of illustration.

FIG. 7 is a perspective cross section of the powered wheel assembly of FIG. 2 with additional detail of a mounting harness and wire conduit.

### DETAILED DESCRIPTION

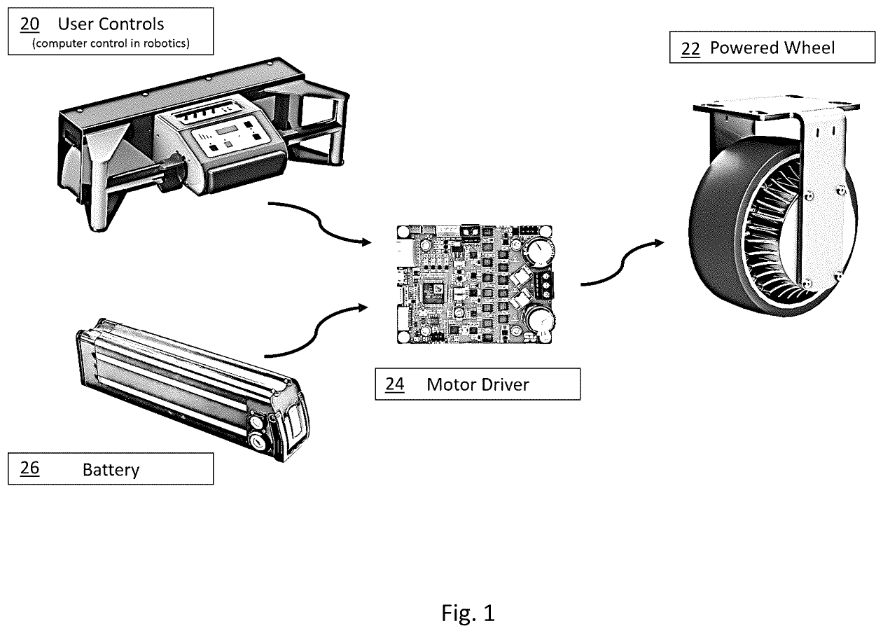

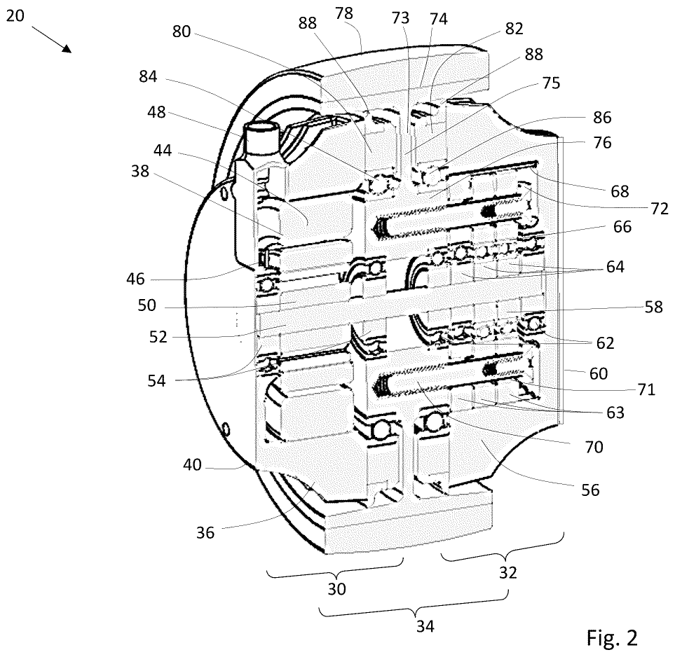

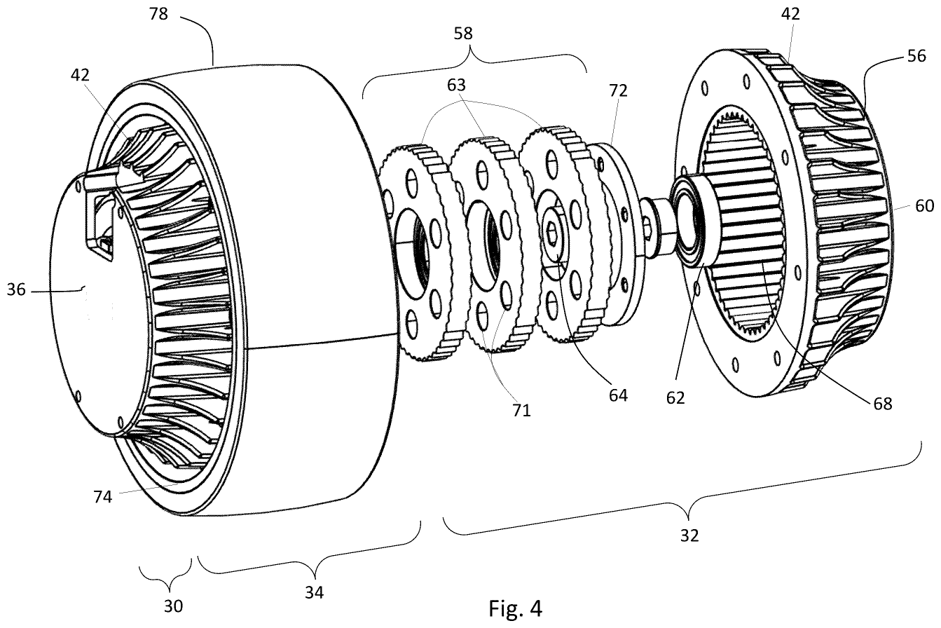

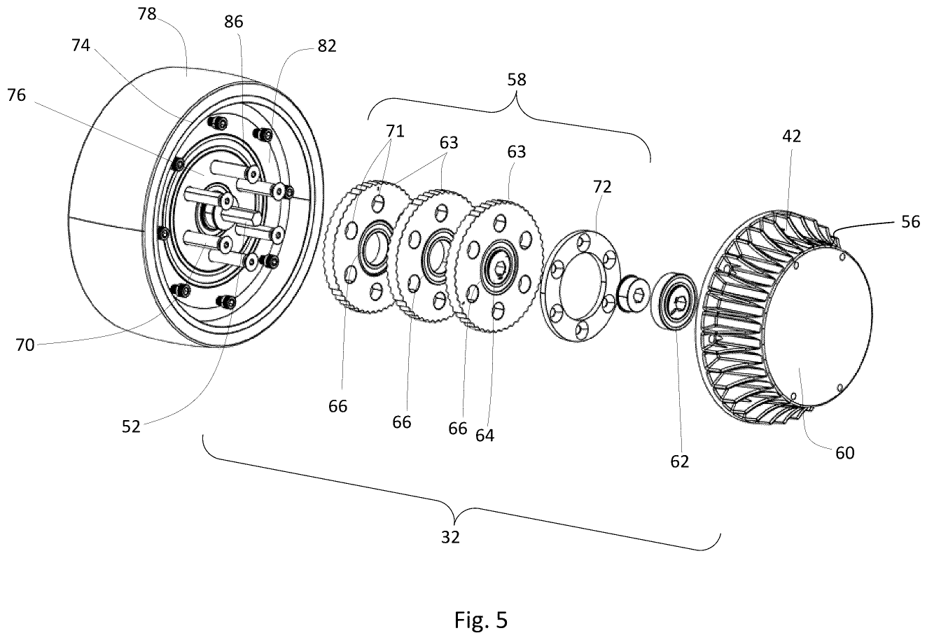

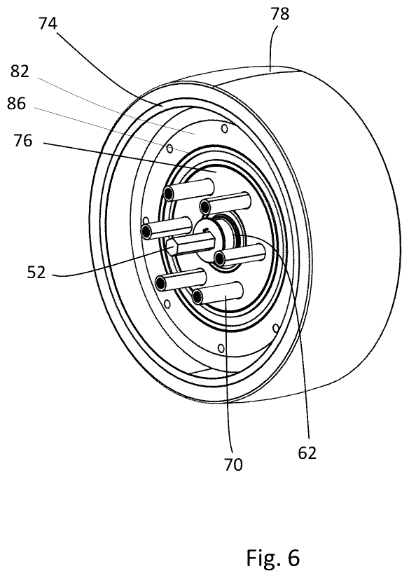

FIG. 1 shows a schematic view of an overall system utilizing the powered wheel assembly including: (i) user controls 20 for controlling the powered wheel assembly 22, for instance, the speed, the direction (forward, reverse), and braking, (ii) a motor driver 24 that interfaces with the motor and generates commands to the motor based on user inputs from the user controls 20, and (iii) a battery 26 power source. The description that follows is primarily directed to the powered wheel assembly 22 and is made with reference to FIGS. 2-7.

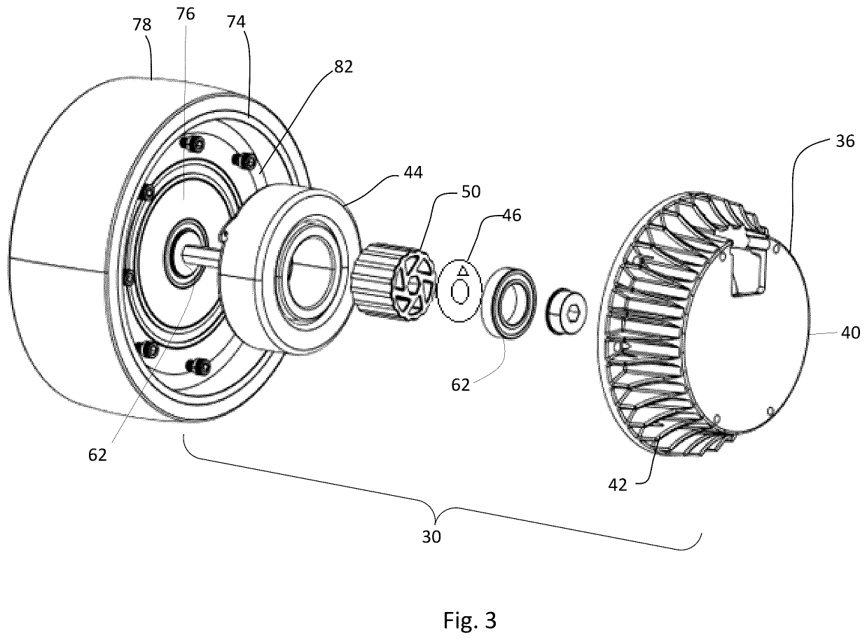

The powered wheel assembly 22 comprises three subassemblies: a motor subassembly 30, a gear drive subassembly 32, and a hub subassembly 34 that is disposed between the motor subassembly 30 and the gear drive subassembly 32. The motor subassembly 30 comprises a motor housing 36 and a motor 38. The motor housing 36 is a generally cylindrically shaped body with an open axial end and a plate member 40 covering over the opposite axial end to define a hollow interior for the motor housing 36. An outer surface of the cylindrically shaped body of the motor housing 36, for instance, the outer diameter surface, may be provided with cooling fins 42. In the interior of the motor housing, a stator 44 and electronic controls 46 for the motor may be disposed. The electronic controls 46 may interface with a motor driver 24 and provide local control signals for the motor. The control of speed, direction and braking of the motor may be provided via a user control 20 interfaced with a motor driver 24 as shown in FIG. 1, and the local motor controls 46 as shown in FIG. 3. A wiring conduit 48 may integrated with the motor housing 36 adjacent to the motor housing plate member 40 to provide wiring for powering and controlling the motor. The motor may comprise a brushless DC motor, and may comprise brushless DC radial flux rotor. The motor may be electrically configured for regenerative braking with charging of the battery, or dissipation through the electronics, of the system as desired. The stator 44 may be positioned adjacent an interior cylindrical wall of the housing 36 and a rotor 50 may be disposed within a core of the stator 44. The rotor 50 may be operatively connected with a shaft 52 extending axially within the motor housing 36 through the axially open end of the motor housing. As shown in the drawings, the rotor 50 is directly coupled to the shaft 52. Thus, the shaft 52 and the rotor 50 may be rotationally supported within the core of the stator 44 with one or more bearing sets 54 mounted in the motor housing. For instance, as shown in the drawings, a bearing set 54 is mounted on the interior exposed surface of the plate member 40 of the motor housing 36 and another bearing set 54 is mounted on the hub assembly 34 at the axial open end of the motor housing 36. However, a transmission system including multiple gears and shafts may be used to connect the rotor to an output shaft, and the bearing supports for each may be positioned in the motor housing 36 interior as needed to support the rotor 50 and such a transmission.

The second of the three subassemblies comprises a gear drive subassembly 32. The gear drive subassembly 32 comprises a gear drive housing 56 and a cycloidal gear drive 58. The gear drive housing 56 is a generally cylindrically shaped body with an open axial end and a plate member 60 covering over the opposite axial end to define a hollow interior for the gear drive housing 56. An outer surface of the cylindrically shaped body of the gear drive housing 56, for instance, the outer diameter surface, may be provided with cooling fins 42. In the interior of the gear drive housing 56, a cycloidal gear drive 58 may be disposed and driven by the drive shaft 52 extending axially into the interior of the gear drive housing 56 from the interior of the motor housing 36. As shown in the drawings, a single drive shaft 52 extends from the rotor 50 directly to the cycloidal gear drive 58. Thus, the drive shaft 52 may be rotationally supported within the interior of the gear drive housing 56 with one or more bearing sets 62 mounted in the gear drive housing 56. For instance, as shown in the drawings, a bearing set 62 is mounted on the interior exposed surface of the plate member 60 of the gear drive housing 56, and another bearing set is mounted to the hub assembly 34 at the axially open end of the gear drive housing. However, a transmission system including multiple gears and shafts may be used to connect the motor to the cycloidal gear drive 58, and the bearing supports for each may be positioned in the gear drive housing interior as needed to support the cycloidal gears and such a transmission.

The cycloidal gear drive 58 comprises at least one cycloidal gear 63. The at least one cycloidal gear 63 may be operatively connected with the shaft with an eccentricity or offset. For instance, the at least one cycloidal gear 63 may be operatively connected with the shaft with via an eccentric hub 64. The eccentric hub 64 may be mounted to the drive shaft 52 in a location of the eccentric hub 64 that is offset relative to a center of the eccentric hub 64. In the alternative, the shaft 52 may be integral or monolithically formed with the hub with a desired eccentricity or offset. A cycloidal gear hub bearing 66 may be disposed between the outer surface of the hub and an inner surface of the cycloidal gear 63, so that the cycloidal gear 63 in effect orbits around the drive shaft 52 in a direction of rotation opposite to that of the drive shaft 52. As shown in the drawings, three cycloidal gears 63 are provided, each with its own eccentric hub 64 mounted to the drive shaft. The phasing of each of the cycloidal gears 63 may be provided to balance loading on the drive shaft 52, for instance, 120 degrees apart.

The cycloidal gear drive 58 may comprise an outer cycloidal ring gear 68. The at least one cycloidal gear 63 may be configured to orbit within the outer cycloidal ring gear 68. As shown in the drawings, the outer cycloidal ring gear 68 of the cycloidal gear drive 58 is integral with the gear drive housing 56 and may be monolithic with the gear drive housing 56. The outer cycloidal ring gear 68 may comprising a toothed cycloidal gear formed in the gear drive housing 56 or may comprise pins mounted in the gear drive housing 56.

The at least one cycloidal gear 63 may be configured to engage at least one carrier pin 70. The at least one carrier pin 70 may be one of six carrier pins 70 configured for engagement with the at least one cycloidal gear 63. Each cycloidal gear 63 may have a drive hole 71 for each carrier pin 70. The drive hole 71 may be located between the outer peripheral surface of the cycloidal gear 58 and the cycloidal gear hub bearing mounting surface and accommodate orbital motion of the carrier pin 70 within the drive hole 71 during rotation of the corresponding cycloidal gear 63. For instance, as shown in the drawings, there may be six drive holes 71 in each cycloidal gear 63 to accommodate the six carrier pins 70. The carrier pins 70 may be supported in the cycloidal gear drive train with a support plate 72 axially outboard of the axial outboard (i.e., the last) cycloidal gear 63 and adjacent the interior exposed surface of the plate member 60 of the gear drive housing 56. Mechanical fasteners may be directed through holes in the support plate 72 into the carrier pins 70 to allow for assembly/disassembly of the gear drive 58.

The third of the three subassemblies comprises the hub subassembly 34. The hub subassembly 34 is disposed between the motor subassembly 30 and the gear drive subassembly 32. The hub subassembly 34 includes a hub 73 having a wheel tread support portion 74 extending radially outward from a center web 75. The center web extends radially outward from a core 76. The wheel tread support portion 74 may be supercircumjacent the motor housing 36 and the gear housing 56. The wheel tread support portion may be generally “T” shaped in cross-section with the wheel tread 78 positioned on an outer periphery thereof. The web 75 of the hub 73 may be disposed axially between the motor and the cycloidal gear drive. The core 76 of the hub 73 may have a central opening, and the drive shaft 52 may pass through the central opening as it extends axially from the rotor 50 directly to the cycloidal gear drive 58. In the alternative, a transmission system between the motor and the cycloidal gear drive 58 may be positioned in the central opening. The at least one carrier pin 70 may be mounted in the core 76 of hub 73 (e.g., threaded into the core) and extend axially outward in a direction away from the motor 38 for engagement with the at least one cycloidal gear 63 via the corresponding cycloidal gear drive hole 71. The hub 73 may include at least one bearing set to support rotation of the drive shaft 52. As shown in the drawings, the core 76 of the hub 73 includes the one bearing set 54 on one axial side adjacent the central opening passage toward the motor 38 and another bearing set 62 on the opposite axial side of the core adjacent the central opening toward the gear drive 58. Preferably, the hub 73 is centered between the motor housing 36 and the gear drive housing 56. Preferably, the wheel tread 78 is centered between and over the motor housing 36 and the gear drive housing 56.

Rotation of the rotor 50 and drive shaft 52 causes eccentric or orbital motion of each of the cycloidal gears 63 within the outer cycloidal ring gear 68 which in turn causes each of the cycloidal gears 63 to drive the carrier pins 70 with rotational motion relative to the motor housing 36 and gear drive housing 56. The drive holes 71 in each of the cycloidal gears 63 engage with a corresponding carrier pin 70 to drive the carrier pins 70 with motion that is orbital relative to the drive hole and rotational relative to the drive shaft 52. Rotational motion of the carrier pins in turn causes rotation of the hub 72 and the wheel tread 76.

The motor housing 36 may include a wheel mounting ring 80, and the gear drive housing 56 may include a wheel mounting ring 82. The wheel mounting ring 78 of the motor housing 36 may be disposed between the hub 72 and the motor housing 36. The motor housing 36 may be operatively connected with the wheel mounting ring 80 of the motor housing 36, for instance, secured to the wheel mounting ring 80 with mechanical fasteners, or otherwise integral or monolithically formed with the wheel mounting ring 80. The mounting ring 82 of the gear drive wheel may be disposed between the hub 73 and the gear drive housing 56. The gear drive housing 56 may be operatively connected with the wheel mounting ring 82 of the gear drive housing 56, for instance, secured to the wheel mounting ring 82 with mechanical fasteners, or otherwise integral or monolithically formed with the wheel mounting ring 82. The hub 73 may be rotationally supported by a bearing set 84 mounted in the wheel mounting ring 80 of the motor housing 36 and a bearing set 86 mounted in the wheel mounting ring 82 of the gear drive housing 56. As shown in the drawings, one bearing set 84 is disposed between an inner diameter surface of the mounting ring 80 of the motor housing 36 and an outer diameter surface of the core 76 of the hub 73, and another bearing set 86 is disposed between an inner diameter surface of the wheel mounting ring 82 of the gear drive housing 56 and an outer diameter surface of the core 76 of the hub 73. At least one of the wheel mounting ring 80 of the motor housing 36 and the wheel mounting ring 82 of the gear drive housing 56 has a thread guard and/or a circumferential seal 88 adjacent the wheel tread support portion 74 of the hub 73 configured for sealing with the wheel tread support portion 74 of the hub 73.

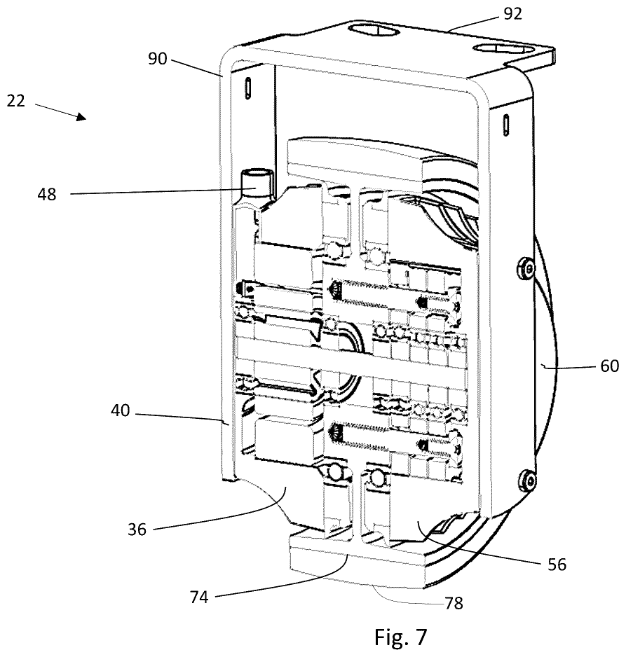

As best shown in FIG. 7, the powered wheel assembly 22 includes a harness 90 for mounting the powered wheel assembly 22 to an object to be moved with the powered wheel assembly 22. The harness 90 comprises a yoke that extends outward from the along the plate member of the motor housing 40 and the plate member of the gear drive housing 60, and includes a top plate 92 configured for mechanical connections to the object.

The present disclosure describes a number of new, useful and nonobvious features and/or combinations of features that may be used alone or together. The multiple separate inventions stand alone and are not intended to require combination with other inventions. Furthermore, the embodiments described herein are all exemplary, and are not intended to limit the scope of the inventions. It will be appreciated that the inventions described herein can be modified and adapted in various and equivalent ways, and all such modifications and adaptations are intended to be included in the scope of this disclosure and the appended claims.

What is claimed is:

1. A powered wheel assembly comprising:
a motor housing comprising a motor, the motor comprising a stator and a rotor disposed within a core of the stator, the rotor being rotationally supported in the motor housing and operatively connected with a shaft extending axially in the interior of the motor housing;
a gear drive housing axially opposite of the motor housing, the gear drive housing comprising a cycloidal gear drive, the cycloidal gear drive comprising at least one cycloidal gear, the at least one cycloidal gear being operatively connected with the shaft, the cycloidal gear drive comprising an outer ring gear, the at least one cycloidal gear being configured to rotate within the outer ring gear, the at least one cycloidal gear being configured to engage at least one carrier pin; and
a hub disposed between the motor housing and the gear drive housing, the hub having a portion extending radially outward and being supercircumjacent the motor housing and the gear drive housing, the hub being rotatably relative to the motor housing and the gear drive housing, the hub having a wheel tread on an outer peripheral surface of the hub, the hub having a web disposed between the motor and the cycloidal gear drive, the at least one carrier pin being mounted in the web and extending axially outward in a direction away from motor for engagement with the at least one cycloidal gear.

2. The powered wheel assembly of claim 1 wherein the web has a central opening and the shaft passes through the central opening.

3. The powered wheel assembly of claim 1 wherein the at least one cycloidal gear is one of three cycloidal gears operatively connected with the shaft.

4. The powered wheel assembly of claim 1 wherein the at least one carrier pin is one of six carrier pins configured for engagement with the at least one cycloidal gear.

5. The powered wheel assembly of claim 1 wherein the outer ring gear of the cycloidal gear drive is integral with the gear drive housing.

6. The powered wheel assembly of claim 5 wherein the outer ring gear is formed on an interior surface of the gear drive housing.

7. The powered wheel assembly of claim 1 further comprising a first and second wheel mounting rings, the first wheel mounting ring being operatively connected with motor housing and being disposed between the hub and the motor housing, the second wheel mounting ring being operatively connected with gear drive housing and being disposed between the hub and the gear drive housing.

8. The powered wheel assembly of claim 7 wherein at least one of the first and the second wheel mounting rings has a circumferential seal adjacent the hub configured for sealing with the hub.

9. The powered wheel assembly of claim 7 wherein the hub is rotationally supported by a bearing set mounted in the first wheel mounting ring and a bearing set mounted in the second wheel mounting ring.

10. The powered wheel assembly of claim 1 wherein at least one of the motor housing and the gear drive housing has fins configured to circulate air about the powered wheel assembly.

11. The powered wheel assembly of claim 1 wherein the at least one cycloidal gear is operatively mounted to the shaft with an eccentric gear hub.

12. The powered wheel assembly of claim 1 wherein the at least one carrier pin passes through a respective drive hole in the at least one cycloidal gear.

13. The powered wheel assembly of claim 1 wherein the shaft extends axially from a connection with the rotor to a connection with the at least one cycloidal gear.

14. The powered wheel assembly of claim 1 wherein the motor is electrically configured for regenerative braking.

15. The powered wheel assembly of claim 1 wherein the motor housing includes a mounting harness configured for mounting the powered wheel assembly to an object to be moved with the powered wheel assembly.

16. The powered wheel assembly of claim 1 wherein the hub is centered between the motor housing and the gear drive housing.

17. The powered wheel assembly of claim 1 wherein the wheel tread is centered between the motor housing and the gear drive housing.

18. The powered wheel assembly of claim 1 wherein the shaft is rotationally supported by a bearing set mounted in the motor housing, a bearing set mounted in the web of the hub, and a bearing set mounted in the gear drive housing.

19. A powered wheel assembly comprising:
a motor subassembly, the motor subassembly comprising a motor, the motor comprising a stator and a rotor disposed within a core of the stator, the rotor having a shaft extending axially through the motor subassembly;
a gear drive subassembly, the gear drive subassembly a cycloidal gear drive, the cycloidal gear drive comprising at least one cycloidal gear, the at least one cycloidal gear being operatively connected with the shaft, the cycloidal gear drive comprising an outer ring gear, the at least one cycloidal gear being configured to rotate within the outer ring gear, the at least one cycloidal gear being configured to engage at least one carrier pin; and
a hub subassembly disposed between the motor subassembly and the gear drive subassembly, the hub subassembly having a portion extending radially outward and being supercircumjacent the motor subassembly and the gear drive subassembly, the hub subassembly being rotatably relative to the motor subassembly and the gear drive subassembly, the hub subassembly including a wheel tread on an outer peripheral surface of a hub of the hub subassembly, the hub having a web disposed between the motor subassembly and the gear drive subassembly, the at least one carrier pin being mounted in the web and extending axially outward in a direction away from motor subassembly for engagement with the at least one cycloidal gear.
